(19) United States
(12) Patent Application Publication
(10) Pub. No.: US 2024/0195744 A1
(43) Pub. Date: Jun. 13, 2024

(54) TRAFFIC PRIORITIZATION IN SD-WAN

(71) Applicant: VMware LLC, Palo Alto, CA (US)

(72) Inventors: Ananya Simlai, London (GB); Ramkumar Venketaramani, Sunnyvale, CA (US)

(21) Appl. No.: 18/442,759

(22) Filed: Feb. 15, 2024

Related U.S. Application Data
(63) Continuation of application No. 17/695,264, filed on Mar. 15, 2022, now Pat. No. 11,943,146.

(30) Foreign Application Priority Data
Oct. 1, 2021 (IN) 202141044684

(51) Int. Cl. H04L 47/2491; H04L 47/2441; H04L 69/22

(52) U.S. Cl. CPC H04L 47/2491; H04L 47/2441; H04L 69/22

(57) ABSTRACT

Some embodiments provide a method, for a software-defined wide area network (SD-WAN) that handles (i) traffic for a 5G network and (ii) traffic outside of the 5G network. The SD-WAN is established by a set of edge nodes and a set of gateways. At a particular edge node of the SD-WAN, the method identifies whether a received data message is a 5G message that includes a tunnel header of a particular type associated with the 5G network. When the data message is a 5G message, the method examines a set of header fields within the tunnel header to identify a specified traffic priority applicable to the 5G message. The method applies the identified traffic priority within the SD-WAN.

### CROSS-REFERENCE TO RELATED APPLICATION

This application is a continuation of U.S. patent application Ser. No. 17/695,264 filed on Mar. 15, 2022, which claims the benefit is claimed under 35 U.S.C. 119(a)-(d) to Indian Application Serial No. 202141044684 filed Oct. 1, 2021, entitled “TRAFFIC PRIORITIZATION IN SD-WAN”, by VMware LLC, both of which are incorporated herein in their entirety by reference for all purposes.

### BACKGROUND

Software-defined wide area networks (SD-WAN) are becoming increasingly common solutions for, e.g., connecting public and/or private cloud datacenters for an enterprise. In an SD-WAN deployment, an edge device typically connects through one or more secure connections with a gateway, with these connections traversing network links that connect the edge device with an external network. As an example, a branch office of an enterprise might operate an SD-WAN edge device that connects to a gateway at an on-premises datacenter. These SD-WANs can handle data traffic for enterprise applications but will often also handle broadband cellular traffic (e.g., 4G or 5G traffic). This broadband cellular traffic will often have its own internal specifications that are opaque to the typical SD-WAN edge or gateway device.

### BRIEF SUMMARY

Some embodiments provide a method for an SD-WAN that handles both traffic for a cellular broadband (e.g., 5G) network as well as traffic outside of the cellular broadband network to intelligently prioritize different types of cellular broadband traffic. When an edge device of the SD-WAN receives a data message, the edge device can determine (e.g., by looking at an Internet Protocol (IP) header of the data message) whether the data message is cellular broadband traffic or not and prioritize the traffic relative to other types of traffic. In addition, if the data message is a cellular broadband data message, the edge device of some embodiments examines a set of header fields of a particular type of tunnel header (e.g., a general packet radio service (GPRS) tunneling protocol (GTP) header) associated with the cellular broadband network. Based on the examination of the set of header fields, the edge device identifies a specified traffic priority applicable to the data message and applies that traffic priority to the data message within the SD-WAN.

The application of the traffic priority helps to ensure end-to-end application of the traffic priority specified for the data message by the cellular broadband network. Thus, for example, the SD-WAN will not result in the deprioritization of latency-sensitive user traffic for cellular broadband applications such as automated vehicles, drones, etc. Similarly, cellular broadband control traffic (e.g., traffic between components of a distributed radio access network) may be latency-sensitive, so the SD-WAN will also avoid deprioritizing this traffic.

The SD-WAN of some embodiments may carry cellular broadband traffic in various different situations. For instance, a large retail store with several locations might deploy an SD-WAN that connects these various locations to each other, to a centralized datacenter, and to other external networks. The edge devices at such a location will process SD-WAN traffic relating to various enterprise applications such as billing, inventory, etc. (e.g., sent from various desktop and/or laptop computers, virtual machines, etc.) at the location in addition to various types of cellular broadband traffic.

In addition, the SD-WAN may carry cellular broadband messages at different locations within the cellular broadband network. A cellular broadband message sent by an endpoint device (commonly referred to as user equipment, or UE), for example, typically travels from the endpoint device to a base station. The base station traditionally includes the radio access network (RAN), though the RAN may be distributed in some cases as described in the Open RAN (O-RAN) standard. After RAN processing, the message is then sent to the packet core. In some embodiments, the SD-WAN handles the cellular broadband messages between the RAN and the packet core, with the edge device located at the RAN and the gateway device located at the packet core. In this case, the edge device processes the cellular broadband message after RAN processing is completed and the gateway device processes the message prior to the message being handled by the packet core.

The SD-WAN of some embodiments may instead handle traffic between components of the distributed RAN. In the O-RAN, RAN components may execute in a cloud rather than directly at the base station, and the SD-WAN handles traffic (e.g., control traffic) between different RAN components (e.g., between the distributed unit and the centralized unit). Similarly, the SD-WAN of some embodiments handles traffic between two different RAN instances (e.g., when a mobile device is handed off from one base station to another).

To identify the traffic priority for a cellular broadband message, the edge device is configured in some embodiments to examine fields beyond just the IP header of the message. Specifically, 5G messages processed by an SD-WAN edge typically include (among other headers) an outer (underlay) IP header, a GTP header, and an inner (overlay) IP header. Within the GTP header, a tunnel endpoint identifier field identifies the GTP tunnel (i.e., encompassing both tunnel endpoints) for a protocol data unit (PDU) session. A single PDU session may include numerous flows, and thus the GTP header may include an extension header that, among other fields, can specify a quality of service (QOS) flow identifier (QFI). This QFI may be used to map to a specific QoS level (e.g., a specific 5G QOS Identifier (5QI)). This QoS level in turn maps to a specific set of characteristics that must be met for the packet, including a priority level, packet delay, packet error rate, etc. With the edge device configured to examine the GTP header, the edge device can enforce these QoS characteristics within the SD-WAN.

In addition, to avoid the need to review the GTP header for each data message in a flow, in some embodiments the edge device stores a mapping of an identifier for the flow to the identifier for the set of QoS characteristics. The flow identifier of some embodiments includes only IP and/or transport layer (e.g., TCP, UDP, etc.) header fields. For instance, in some embodiments the flow identifier includes the outer IP header fields, inner IP header fields, and one or more transport layer port numbers (e.g., source and/or destination port numbers) from the inner and/or outer transport layer header.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates an example of a situation in which an SD-WAN also carries cellular broadband traffic.

FIG. 2 conceptually illustrates an example of an SD-WAN being situated between the 5G RAN and the 5G packet core.

FIG. 3, on the other hand, illustrates a case when traffic within a RAN passes through an SD-WAN.

FIG. 4 illustrates the case of traffic between two 5G base stations being carried through an SD-WAN.

FIG. 5 conceptually illustrates a process of some embodiments for applying different traffic priorities to different types of traffic, including different types of 5G traffic.

FIG. 6 conceptually illustrates a pair of PDU sessions for an endpoint device that illustrate how multiple flows are contained within a single PDU session.

FIG. 7 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for an SD-WAN that handles both traffic for a cellular broadband (e.g., 5G) network as well as traffic outside of the cellular broadband network to intelligently prioritize different types of cellular broadband traffic. When an edge device of the SD-WAN receives a data message, the edge device can determine (e.g., by looking at an Internet Protocol (IP) header of the data message) whether the data message is cellular broadband traffic or not and prioritize the traffic relative to other types of traffic. In addition, if the data message is a cellular broadband data message, the edge device of some embodiments examines a set of header fields of a particular type of tunnel header (e.g., a general packet radio service (GPRS) tunneling protocol (GTP) header) associated with the cellular broadband network. Based on the examination of the set of header fields, the edge device identifies a specified traffic priority applicable to the data message and applies that traffic priority to the data message within the SD-WAN.

The application of the traffic priority helps to ensure end-to-end application of the traffic priority specified for the data message by the cellular broadband network. Thus, for example, the SD-WAN will not result in the deprioritization of latency-sensitive user traffic for cellular broadband applications such as automated vehicles, drones, etc. Similarly, cellular broadband control traffic (e.g., traffic between components of a distributed radio access network) may be latency-sensitive, so the SD-WAN will also avoid deprioritizing this traffic.

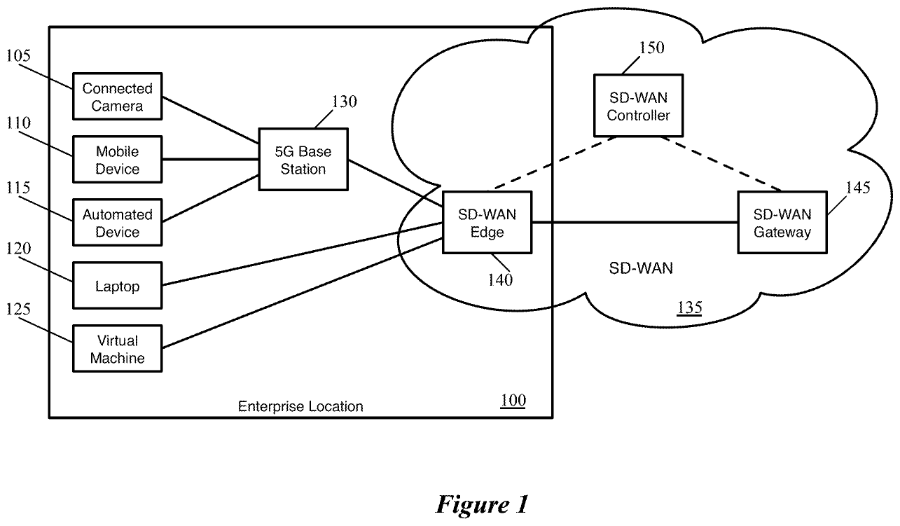

FIG. 1 conceptually illustrates an example of a situation in which an SD-WAN also carries cellular broadband traffic (specifically, 5G traffic). It should be understood that while much of the discussion in this application refers specifically to 5G traffic, similar concepts apply to other cellular broadband traffic, such as 3G, 4G, etc. In the example of FIG. 1, numerous connected endpoint devices 105-125 operate at an enterprise location 100. The enterprise location 100 could be, e.g., a retail store (e.g., a department store, a home improvement retailer, a supercenter, etc.), a manufacturing plant, a hospital, a research organization, etc.

In this example, the connected endpoint devices include a connected camera 105, a mobile device 110 (e.g., a smart phone, a tablet, etc.), an automated device 115 (e.g., automated manufacturing equipment, a self-driving vehicle, etc.), a laptop 120, and a virtual machine 125. Three of these devices 105-115 are 5G devices that connect to a 5G base station 130 (e.g., a 5G small cell that operates within the enterprise location 100), while two of the devices 120-125 connect via wired (e.g., Ethernet) or wireless (e.g., 802.11 Wi-Fi) forms of connectivity. In many situations, various other types of connected devices (both 5G devices and non-5G devices) will operate within such an environment. Examples of such 5G devices include remote surgery equipment, remote controlled drones, smart watches, health monitoring equipment, Internet of Things (IOT) appliances, etc., while other non-5G devices could include desktop computers, servers, containers, etc.

Both the 5G base station 130 and the other forms of communication communicate externally via a software-defined wide area network (SD-WAN) 135. This communication includes enterprise application traffic (for billing, inventory, etc.) from the laptop 120 and/or virtual machine 125 as well as various types of 5G traffic (e.g., 5G voice traffic and/or 5G Internet traffic). The SD-WAN 135 of some embodiments may be used to connect multiple branch sites (e.g., the enterprise location 100) to at least one datacenter hub. In this example, the SD-WAN includes at least an edge device 140, a gateway 145, and a controller 150, though in many cases an SD-WAN will include multiple edge devices (e.g., for each of many branch offices, retail locations, etc.), multiple gateways, and/or a hub.

The SD-WAN edge device 140 may be a virtual machine, a container, a program executing on a physical or virtual machine, a stand-alone appliance, etc., that operates at the enterprise location 100 to connect the devices at that location to other devices, hubs, etc. in the SD-WAN or connected to the SD-WAN. Though shown as a single edge 140, this represents a high-availability pair or cluster in some embodiments.

The edge device 140 (and, in many cases, other edge devices of the SD-WAN) exchanges data traffic with the SD-WAN gateway 145 through one or more connection links (e.g., a cable modem link, a fiber optic link, and/or an MPLS link, etc.). The gateway 145 (or a hub, which is not shown in this figure) connects the edge device 140 to other edges (e.g., at other enterprise locations). The gateway 145 may be located in an on-premises datacenter (e.g., a primary datacenter for an enterprise). In some embodiments, traffic from the endpoint devices 105-125 at the enterprise location 100 that is directed externally (e.g., to external destinations not associated with the enterprise location) is routed through the SD-WAN to the gateway 145 before being sent through a public network to its external destination. This includes the 5G traffic from the devices 105-115.

The controller 150, which may be a single controller or a cluster of controllers, serves as a central point for managing (e.g., defining and modifying) configuration data that is provided to the edge 140 and gateway 145, as well as any other SD-WAN nodes (e.g., other edges, hubs, gateways, etc.), to configure some or all of the operations of these SD-WAN nodes. The controller 150 may be located in a private datacenter (e.g., a primary enterprise datacenter) or in a public cloud datacenter (or in multiple datacenters, if operating as a cluster). In some embodiments, the controller 150 actually includes a set of manager servers that define and modify the configuration data, and a set of controller servers that distribute the configuration data to the edge 140, gateway 145, and any other SD-WAN nodes. The configuration data provided to the edge 140 may include routing information (e.g., directing the edge 140 to route data to the gateway 145) as well as tunneling information, quality of service (QOS) configuration information, etc.

Because the 5G base station 130 is located within the enterprise location 100, the SD-WAN 135 is used to carry 5G traffic between the base station 130 and other components of the 5G network. User data traffic from the endpoint devices 105-115 may need to travel to the 5G packet core, traffic may need to be sent from the base station 130 to another base station, a radio access network (RAN) component at the base station 130 may communicate with another RAN component located in a public cloud, etc.

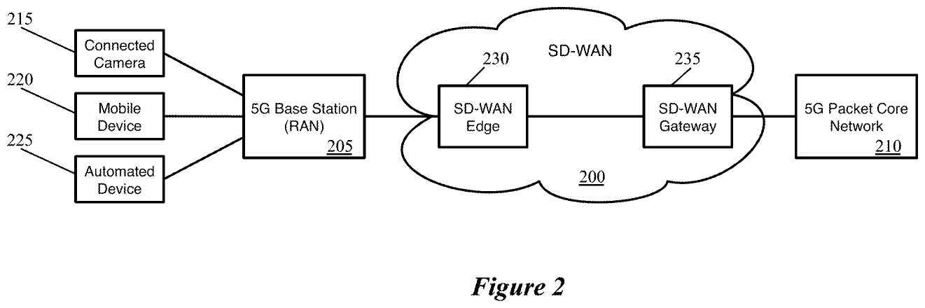

FIG. 2 conceptually illustrates an example of an SD-WAN 200 being situated between the 5G RAN 205 and the 5G packet core 210. The 5G network, like previous cellular broadband networks, includes a RAN that is often situated at each base station of the 5G network as well as a packet core, both of which are typically operated by a mobile provider. The RAN 205 implements the radio access technology that allows endpoint devices to wirelessly connect to the 5G network and is generally the access point for these devices. For a cellular broadband network, there are typically many RANs (e.g., at each base station, which serve separate (though often partially overlapping) geographic areas. The packet core is a more centralized network of the mobile provider (though this core may also be implemented in a distributed manner in multiple public and/or private clouds). In some embodiments, the packet core applies various network functions (e.g., load balancing, firewall, etc.) to 5G data messages.

In the example of FIG. 2, traffic from the devices 215-225 that connect to the 5G base station 205 have RAN processing applied and are then sent to the packet core 210. However, for data messages to reach the packet 210, these data messages must pass through the SD-WAN 200. Thus, the edge device 230 processes this traffic after RAN processing and tunnels the traffic to the gateway device 235, which processes the traffic prior to handing the traffic to the packet core 210.

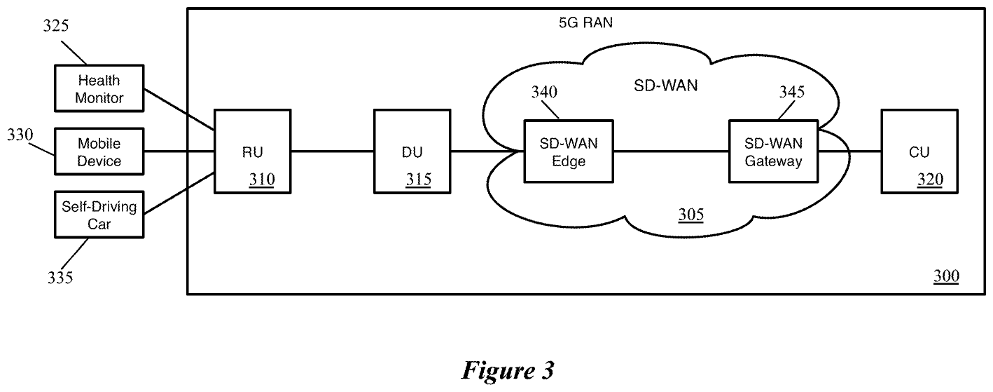

FIG. 3, on the other hand, illustrates a case when traffic within a RAN 300 passes through an SD-WAN 305. In many cases, the distributed unit (DU) of a RAN is located at the base station along with a radio unit (RU), while the centralized unit (CU) may be located in a cloud and control numerous DUs. The RU 310, in some embodiments, provides functions such as analog to digital conversion, filtering, power amplification, and TX/RX, and may be integrated with the antenna of a base station. The DU 315, in some embodiments, provides digital processing, including signal modulation, encoding, scheduling, and other functions. The CU 320 provides radio resource control and packet data convergence protocol layers. In addition to communication from endpoint devices 325-335 being sent through the RAN 300 and therefore from the DU 315 through the SD-WAN 305 to the CU 320, control communications are often sent between the DU 315 and the CU 320 as well. In this case, for messages to reach the CU 320 from the DU 315, these messages must pass through the SD-WAN 305. Thus, the edge device 340 processes this traffic after the DU 315 and tunnels the traffic to the gateway device 345, which processes the traffic prior to sending the traffic to the CU 320.

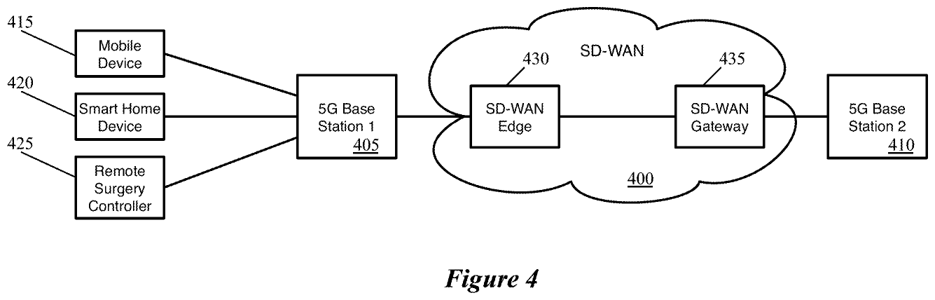

FIG. 4 illustrates the case of traffic between two 5G base stations 405 and 410 being carried through an SD-WAN 400. The X2 interface defines communication between base stations. These communications can include user data or signaling information. For instance, one base station communicates with another when handling handover of a device from one base station to another (e.g., because that device is in motion and moves from the geographic area of the first base station to the geographic area of the second base station). In the figure, the mobile device 415 is more likely to cause such communication between the base stations 405 and 410 than either the smart home device 420 or the remote surgery controller 425, as the latter two endpoint devices are more likely to be static. Like the two previous examples, in order for X2 messages to be sent from the first 5G base station 405 to the second 5G base station 410, the edge device 430 processes this traffic after the first base station 405 and tunnels the traffic to the gateway device 435, which processes the traffic prior to sending the traffic to the second base station 410.

Other 5G traffic might pass through an SD-WAN as well, in some embodiments. For instance, Open RAN (O-RAN) implementations can push many of the RAN functionalities (e.g., DU and/or CU operations) to a near-real-time RAN intelligent controller (RIC), which hosts applications (referred to as xApps). Communication on the E2 interface between the CU and DU components and the near-real-time RIC, as well as between RIC components and the xApps or between xApps, may be very latency-sensitive while passing through an SD-WAN. Further detail about the near-real-time RIC, xApps, and messages between these components can be found in U.S. patent Ser. No. 17/384,777, filed Jul. 25, 2021, which is incorporated herein by reference.

Many of these examples of 5G traffic have extremely low latency requirements. Applications like remote surgery, automated cars or manufacturing, remote machinery control, as well as various types of control messaging, require very high quality of service and cannot be caught up in delays that could occur if there is a bottleneck in the SD-WAN (e.g., if other non-5G traffic increases for a period of time). However, the edge nodes in SD-WAN deployments generally prioritize traffic based on the standard network layer (e.g., IP) data message headers (e.g., by examining the differentiated services code point (DSCP) field) in order to differentiate between traffic. While this can work in some cases to differentiate 5G traffic from other traffic, not all 5G traffic should be given the same priority. For instance, remote surgery or automated vehicle traffic should have a higher priority than mobile phone web browsing.

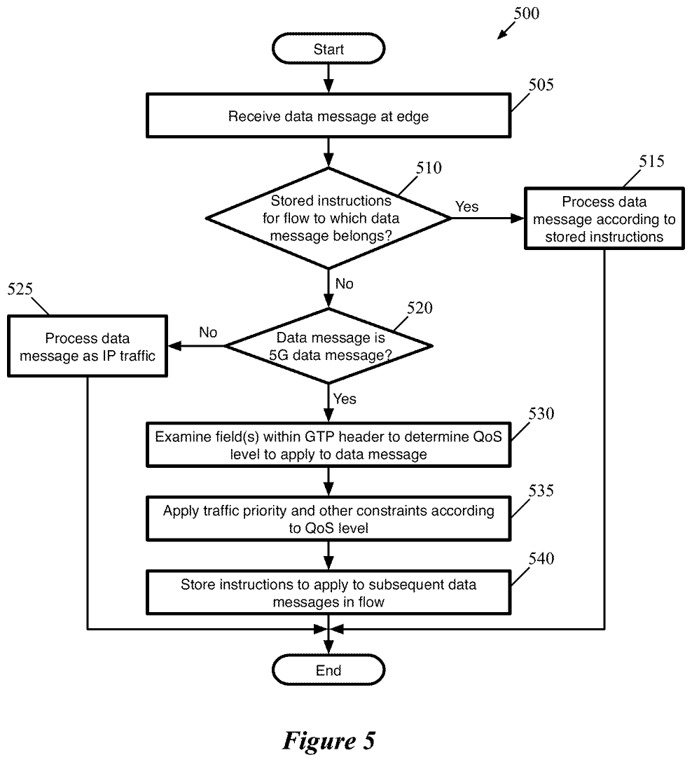

Therefore, to identify the traffic priority for a cellular broadband message, the SD-WAN edge device is configured in some embodiments (e.g., by the SD-WAN controller) to examine fields beyond just the IP header of the message. FIG. 5 conceptually illustrates a process 500 of some embodiments for applying different traffic priorities to different types of traffic, including different types of 5G traffic. The process 500 is performed by an SD-WAN edge node in some embodiments (e.g., by an SD-WAN edge) that handles 5G traffic in addition to non-5G traffic. In some embodiments, SD-WAN gateways also perform similar operations (e.g., for reverse direction traffic).

As shown, the process 500 begins by receiving (at 505) a data message at the edge device. In some embodiments, this is a data message with an outer IP header. Internally, the data message may be a 5G user data message, a 5G control message, a non-5G message (e.g., an enterprise application message, etc.).

The process 500 determines (at 510) whether stored instructions exist for the flow to which the data message belongs. In some embodiments, the edge device stores a mapping of flow identifiers to processing instructions, which include QoS level information as well as forwarding instructions. The flow identifier of some embodiments includes only IP and/or transport layer (e.g., TCP, UDP, etc.) fields, so that for these data messages the edge device does not need to examine any of the other fields. For instance, in some embodiments the flow identifier includes IP header fields and/or transport layer port numbers (e.g., source and/or destination port numbers) of an outer (encapsulation) header. Some embodiments also include IP and/or transport layer fields from an inner (overlay network) header. As described below, when a data message from a new flow is received and processed, the edge device stores a mapping of the flow identifier for that flow to processing instructions for the flow.

If instructions are stored for the flow to which the received data message belongs, then the process 500 processes (at 515) the data message according to the stored instructions. As mentioned, in addition to specifying forwarding instructions (e.g., routing) for the data message, the stored instructions also indicate a priority for the data message and other QoS-related instructions (e.g., the maximum allowable delay, etc.). This priority may be used by the edge device to schedule transmission of the processed data message relative to other data messages with different priorities. The process 500 then ends.

On the other hand, if no instructions are stored for the flow (e.g., because the data message is the first message in a new flow), the process 500 determines (at 520) whether the data message is a 5G data message. In some embodiments, the edge device can identify a data message as a 5G data message based on a DSCP marking or by identifying the presence of a tunnel header of a particular type associated with 5G data messages (e.g., a GTP header).

If the data message is not a 5G data message, then the process 500 processes (at 525) the data message as IP traffic, using any forwarding and traffic priority configuration configured for the edge device by the SD-WAN controller. This processing can differentiate between different applications based on various factors. For instance, an administrator could configure the SD-WAN to assign higher priority to certain enterprise applications that require lower latency as compared to less latency-sensitive applications (e.g., billing). The process then ends.

When the received data message is a 5G message, the process 500 examines (at (535) a set of fields within the GTP header to determine a QoS level to apply to the data message. In some embodiments, a GTP header includes, among other fields, a tunnel endpoint identifier (TEID) field. This TEID field specifies a tunnel and therefore conveys both endpoints of the tunnel rather than using a separate field for the source and destination tunnel. However, the TEID field on its own is not enough to determine the QoS level, as each GTP tunnel maps to a protocol data unit (PDU) session, which itself may contain numerous separate flows that should be treated differently. The GTP tunnel, in some embodiments, provides connectivity between the endpoint device (UE) and a destination network (e.g., the Internet or a private corporate network). Other fields typically found in the GTP header include a version field, a protocol type extension header flag, a sequence number flag, an N-PDU number flag, a message type, a length, and an extension header type.

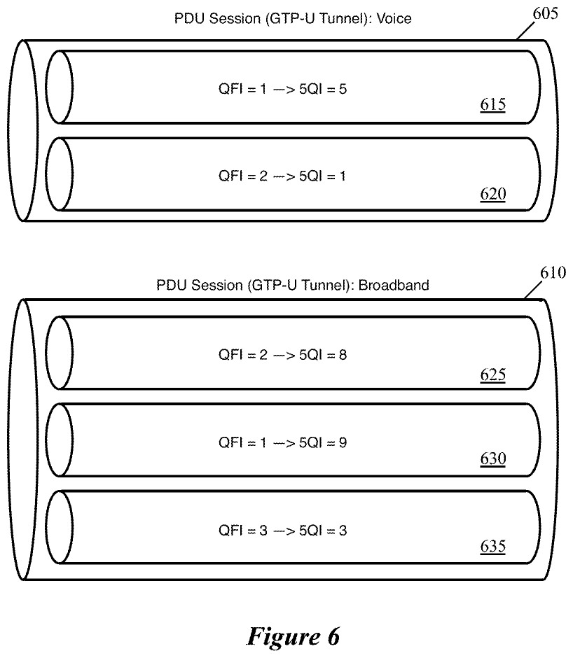

FIG. 6 conceptually illustrates a pair of PDU sessions (GTP-U tunnels) for an endpoint device that illustrate how multiple flows (e.g., for different applications) are contained within a single PDU session. A first PDU session 605 is used for “voice” applications, which can include flows for videoconferencing, conversational voice (telephone), push-to-talk, and short message service (SMS), among other traffic. A second PDU session 610 is used for broadband applications, which can include flows for a multitude of different applications depending on the sort of endpoint device initiating the PDU session, including web browsing, connected camera, automated vehicle applications, health monitoring applications, smart home applications, etc.

While DSCP marking can be associated with a PDU session in some embodiments, this does not help differentiate between the different flows within a PDU session. Thus, the edge device is configured in some embodiments to examine additional information within the GTP header that provides additional information about the particular flow to which a data message belongs. In some embodiments, an extension header within the GTP header includes a PDU session container header, which in turn includes a QoS flow identifier (QFI) field. This QFI field can be used to differentiate between different flows and even to map to a particular QoS level that should be applied. In FIG. 6, for example, the voice PDU session 605 includes two different flows: a first flow 615 identified by a QFI value of 1 and a second flow 620 identified by a QFI value of 2. The broadband PDU session 610 includes three flows: a first flow 625 identified by a QFI value of 2, a second flow 630 identified by a QFI value of 1, and a third flow 635 identified by a QFI value of 3. It should be noted that the QFI values need not be assigned starting from 1 and increasing as flows are added to a PDU session; rather, the flow identifier is assigned to correspond to a type of application in some embodiments. In addition, as evidence by this example, the same QFI can be used (and have a different meaning) within a voice PDU session and a broadband PDU session.

The edge device is configured to map the QFI to a QoS level in some embodiments. In some such embodiments, the QoS level is determined according to a 5G QoS identifier (5QI) value, which itself maps to a specific set of QoS characteristics. In the example shown in FIG. 6, the first flow 615 is mapped (based on a QFI of 1) to a 5QI value of 5 and the second flow 620 is mapped (based on a QFI of 2) to a 5QI value of 1. For the broadband flows, the first flow 625 is mapped (based on a QFI of 2) to a 5QI value of 8, the second flow 630 is mapped (based on a QFI of 1) to a 5QI value of 9, and the third flow 635 is mapped (based on a QFI of 3) to a 5QI value of 3.

In some embodiments, rather than using the QFI field, the edge device is configured to use a service class identifier (SCI) field, which is also part of the GTP extension header. A large range of this SCI field is unassigned and can be customized, so the SD-WAN edge can be customized to map SCI values to QoS levels (e.g., to 5QI values). In various embodiments, the edge device classifies traffic into different QoS levels based on some combination of the TEID, transport layer port numbers (e.g., from the outer or inner header), the QFI, DSCP marking in the outer IP header, and the SCI. In addition, in some embodiments, a RAN container (or new radio (NR) RAN container) field within the extension header may be used to classify front haul traffic vs. backhaul traffic and prioritize traffic for distributed RAN solutions between X2-U, Xn-U, and F1-U user plane interfaces. Finally, the PDU session container is used in some embodiments to classify backhaul traffic to N3 and N9 user plane interfaces, between NG-RAN and user plane function (UPF), or between two UPFs.

Returning to FIG. 5, the process 500 applies (at 535) the traffic priority and other constraints according to the identified QoS level. In some embodiments, 5QI values map to both guaranteed bit-rate (including delay-critical guaranteed bit-rate) as well as non-guaranteed bit-rate processing. The 5QI values, in addition, map to a priority level, a packet delay budget, a packet error rate, a maximum data burst volume, and a default averaging window. Thus, the 5QI value enables the edge device to treat traffic for different 5G applications differently, depending on the requirements of that application. As part of processing the data message, the edge device also performs forwarding (e.g., routing of the data message) and outputs the data message (e.g., via an SD-WAN link).

Because instructions were not previously stored, the process 500 then stores (at 540) instructions to apply to subsequent data messages in the flow. In some embodiments, the edge device stores a mapping of flow identifiers to processing instructions (e.g., the QoS level information as well as forwarding instructions). As described above, the flow identifier of some embodiments includes IP header fields and/or transport layer port numbers (e.g., source and/or destination port numbers) of an outer (encapsulation) header and/or from an inner (overlay network) header. The process 500 then ends.

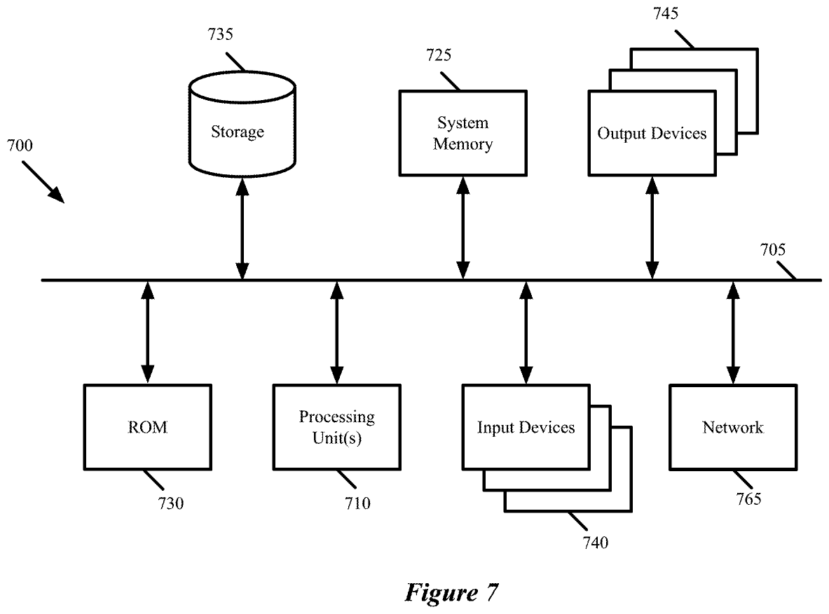

FIG. 7 conceptually illustrates an electronic system 700 with which some embodiments of the invention are implemented. The electronic system 700 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the electronic system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) may be a single processor or a multi-core processor in different embodiments.

The read-only-memory (ROM) 730 stores static data and instructions that are needed by the processing unit(s) 710 and other modules of the electronic system. The permanent storage device 735, on the other hand, is a read-and-write memory device. This device is a non-volatile memory unit that stores instructions and data even when the electronic system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device. Like the permanent storage device 735, the system memory 725 is a read-and-write memory device. However, unlike storage device 735, the system memory is a volatile read-and-write memory, such a random-access memory. The system memory stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices enable the user to communicate information and select commands to the electronic system. The input devices 740 include alphanumeric keyboards and pointing devices (also called “cursor control devices”). The output devices 745 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 7, bus 705 also couples electronic system 700 to a network 765 through a network adapter (not shown). In this manner, the computer can be a part of a network of computers (such as a local area network (“LAN”), a wide area network (“WAN”), or an Intranet, or a network of networks, such as the Internet. Any or all components of electronic system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIG. 5) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

What is claimed is:

1. A method, comprising:
receiving a first data message at a first node;
determining a first type of the first data message;
determining a first traffic priority of the first data message by examining a first tunnel header of the first data message, the first tunnel header comprises a general packet radio service (GPRS) tunneling protocol (GTP) header; and
applying the first traffic priority to the first data message.

2. The method of claim 1, wherein the first data message comprises a cellular broadband data message.

3. The method of claim 1, wherein the first data message comprises a 5G message.

4. The method of claim 1, wherein the first node is located at a radio access network (RAN).

5. The method of claim 1, wherein the first tunnel header is associated with a cellular broadband network.

6. The method of claim 1, further comprising identifying a first identifier within the first tunnel header, the first identifier being associated with the first traffic priority.

7. The method of claim 6, wherein the first identifier comprises an outer IP header field, an inner IP header field, or a transport layer port number.

8. The method of claim 6, further comprising:
storing a mapping between the first identifier and the first traffic priority; and
applying the first traffic priority to a second data message received at the first node.

9. The method of claim 1, wherein the first traffic priority comprises a first quality of service (QOS) level.

10. The method of claim 1, wherein the first data message comprises a non-5G message.

11. A system, comprising:
an input configured to receive a first data message;
a processor coupled to the input, the processor being configured to:
determine a first type of the first data message;
determine a first traffic priority of the first data message by examining a first tunnel header of the first data message, the first tunnel header comprises a general packet radio service (GPRS) tunneling protocol (GTP) header; and
apply the first traffic priority to the first data message.

12. The system of claim 11, wherein the first data message comprises a cellular broadband data message.

13. The system of claim 11, wherein the first data message comprises a 5G message.

14. The system of claim 11, wherein the processor is further configured to identify a first identifier within the first tunnel header, the first identifier is associated with the first traffic priority.

15. The system of claim 14, further comprising a memory configured to store a mapping between the first identifier and the first traffic priority.

16. The system of claim 11, wherein the first traffic priority comprises a first quality of service (QOS) level.

17. A method, comprising:
receiving a first data message at a first node, the first data message comprising a cellular broadband data message;
determining a first type of the first data message;
determining a first traffic priority of the first data message by examining a first tunnel header of the first data message; and
applying the first traffic priority to the first data message.

18. The method of claim 17, wherein the first tunnel header comprises a general packet radio service (GPRS) tunneling protocol (GTP) header.

19. The method of claim 17, wherein the first tunnel header is associated with a cellular broadband network.

20. The method of claim 17, further comprising identifying a first identifier within the first tunnel header, the first identifier being associated with the first traffic priority.
